(19) United States
(12) Patent Application Publication
(10) Pub. No.: US 2025/0378377 A1
(43) Pub. Date: Dec. 11, 2025

(54) DETECTING MODEL MEMORIZATION WITH LOCAL INTRINSIC DIMENSIONALITY

(71) Applicant: THE TORONTO-DOMINION BANK, TORONTO (CA)

(72) Inventors: Brendan Leigh Ross, TORONTO (CA); Hamidreza Kamkari, TORONTO (CA); Zhaoyan Liu, TORONTO (CA); Tongzi Wu, TORONTO (CA); George Frazer Stein, Port Coquitlam (CA); Gabriel Loaiza Ganem, TORONTO (CA); Jesse Cole Cresswell, TORONTO (CA); Maksims Volkovs, TORONTO (CA)

(21) Appl. No.: 19/219,299

(22) Filed: May 27, 2025

Related U.S. Application Data
(60) Provisional application No. 63/656,826, filed on Jun. 6, 2024.

(51) Int. Cl. G06N 20/00

(52) U.S. Cl. CPC G06N 20/00

(57) ABSTRACT

Local intrinsic dimensionality (LID), when evaluated on a data sample for a generative model, can be used to detect model memorization by comparing the LID determined according to the model parameters with a threshold. This allows detection of memorization by the generative model that reproduces a training data sample as well as memorization that presents low degrees of freedom relative to a ground truth dimensionality of the data set. When data samples are generated by the generative model, the LID of the data samples is evaluated to detect memorization, and memorized data samples may be prevented from delivery as generated data samples. During training, training data samples are evaluated for memorization and may be used to modify the training process to reduce memorization.

### CROSS-REFERENCE TO RELATED APPLICATION

This application claims the benefit of U.S. Provisional Application No. 63/656,826, filed Jun. 6, 2024, the contents of which is hereby incorporated by reference in its entirety.

### BACKGROUND

This disclosure relates generally to detecting memorization in generative models and more particularly to detecting memorization with local intrinsic dimensionality of a data sample.

As deep generative models (DGMs) have progressed, recent work has shown that they are capable of memorizing and reproducing training data samples when deployed. These findings call into question the usability of generative models, especially in light of the legal and privacy risks brought about by memorization.

DGMs, and particularly diffusion models (DMs), have featured in the “generative AI” boom with their ability to generate realistic and diverse images from text prompts. They have also been applied successfully in other domains, such as tabular data and language. DMs are thus likely to be deployed in an increasing number of public-facing or safety-critical applications. However, when sufficiently powerful, DGMs can memorize their training data. Memorization occurs at various degrees of specificity, including identities of brands, layouts of specific scenes, or exact copies of images.

Memorization is undesirable for myriad reasons. Failing to generalize from the training data yields a model that reproduces its training data and may be no more useful than the training data itself. Memorization is a modeling failure under a definition of DGMs that focuses on learning a ground truth probability distribution; presumably, the idealized ground truth does not place positive probability mass on individual data samples, so a learned probability distribution that memorizes may be failing to generalize. However, memorization's risks go beyond mere utility. Training data sets in many contexts may contain private personal information which, if memorized, might be exposed in downstream applications. In addition, reproduced training samples can also open up model builders or users to legal liability; for instance, generated images that improperly reproduce training data or generate “substantially similar” training data without appropriate detection or handling may introduce legal risk to operators of the generative model.

### SUMMARY

To evaluate memorization for a generative model with respect to a particular data sample, the local intrinsic dimensionality of the data sample as understood by the generative model parameters is evaluated and used to detect memorization. The local intrinsic dimensionality may represent the “degrees of freedom” of the data sample with respect to the generative model (i.e., according to the model parameters) while remaining on a learned manifold. During training, the generative model may effectively characterize the output space as one or more manifolds to represent the training data, such that different regions of the output space (i.e., the generated output space) may lie on manifolds of different dimensionality. Thus, the learned output space can be understood as a “union of manifolds”-different manifolds having different dimensionalities at different regions of the output space as learned by the model. The local intrinsic dimensionality may estimate the dimensionality of the learned manifold at a particular location (i.e., for a specific data sample), according to the model's learned parameters.

To detect memorization, the local intrinsic dimensionality is determined for a data sample and compared with a threshold. Memorization may include both reproduction (or near reproduction) of a data sample, as well as insufficiently generalized regions of the output space (i.e., the model's learned dimensionality at that point is significantly lower than the dimensionality of the ground truth distribution). In one embodiment, the threshold is 0, 1, or 2 to detect reproduction of a particular data sample. In additional embodiments, the threshold is set based on the dimensionality of the ground truth distribution (e.g., based on an estimate of local data samples). Data samples may be evaluated to detect memorization for generated data samples as well as to improve training of the generative model itself.

For a generated data sample by the model, the generated data sample may be evaluated to determine its local intrinsic dimensionality according to the trained model parameters. When the local intrinsic dimensionality is below a threshold, the generated data sample is determined to be memorized by the model. When the data sample is determined to be memorized, the data sample may be prevented from delivery as an output of the model, preventing reproduction and delivery of generated data samples likely to be a reproduction of a training data sample. The evaluation of the local intrinsic dimensionality may also be evaluated with respect to additional inputs, such as a query, and used to modify the inputs (i.e., the query) to increase the local intrinsic dimensionality of the model's output. In one embodiment, one or more tokens of the query are identified that contribute to the local intrinsic dimensionality and may be modified to generate a modified query for generating a modified data sample with the generative model. The tokens to modify may be based on differentiating the estimated local intrinsic dimensionality with respect to the query. In one embodiment, the tokens are modified with a large language model applied to the original query to maintain the conceptual meaning of the query with alternate tokens or terms. The modified data sample may then be output as a result from the generative model.

Detecting memorization may also be used during training to improve model performance and reduce memorized data samples. Particularly, after training of the generative model, training data samples may be evaluated to determine the local intrinsic dimensionality according to the trained model parameters to determine whether training data samples are memorized. This may include determining that the evaluated local intrinsic dimensionality for data samples evaluated with parameters of the generative model are lower than the estimated dimensionality for the ground truth distribution. When training data sample points are memorized, training of the generative model may be modified to reduce memorized data samples. For example, memorized data samples may be removed from the training data and the model is retrained to prevent the model from accessing and memorizing those data samples. In additional examples, to reduce memorization, additional data samples may be obtained for the training data set, for example in region(s) in which data samples were considered memorized. In additional examples, architecture of the generative model may be modified to affect the likelihood of the model overfitting particular data samples, such that the training data sample memorization may be compared across different model architectures and training processes.

Together, the detection of memorized data samples with local intrinsic dimensionality (according to the generative model) provides a “geometric” understanding of memorization that enables memorization detection specific to a particular data sample and trained model. This also permits evaluation of generated data samples for memorization based on the generative model and without specific comparison to training data samples. Similarly, this approach may detect memorization of training data samples according to the “degrees of freedom” when the training data samples are evaluated, enabling this geometric understanding of memorization to capture when a model may reproduce different but “too-similar” data samples to the training data.

### BRIEF DESCRIPTION OF THE DRAWINGS

FIG. 1 illustrates an example generative modeling system, according to one embodiment.

FIGS. 2A-C show example training data samples with learned manifolds and memorization indicated by local intrinsic dimensionality.

FIG. 3 shows an example of memorization detectable with latent intrinsic dimensionality for a von Mises distribution, according to one or more embodiments.

FIG. 4 is a flowchart of an example process for detecting memorization of a data sample by a generative model, according to one embodiment.

FIG. 5 shows an example method for detecting memorization for generated model samples, according to one embodiment.

FIG. 6. is an example process for using data memorization during model training, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

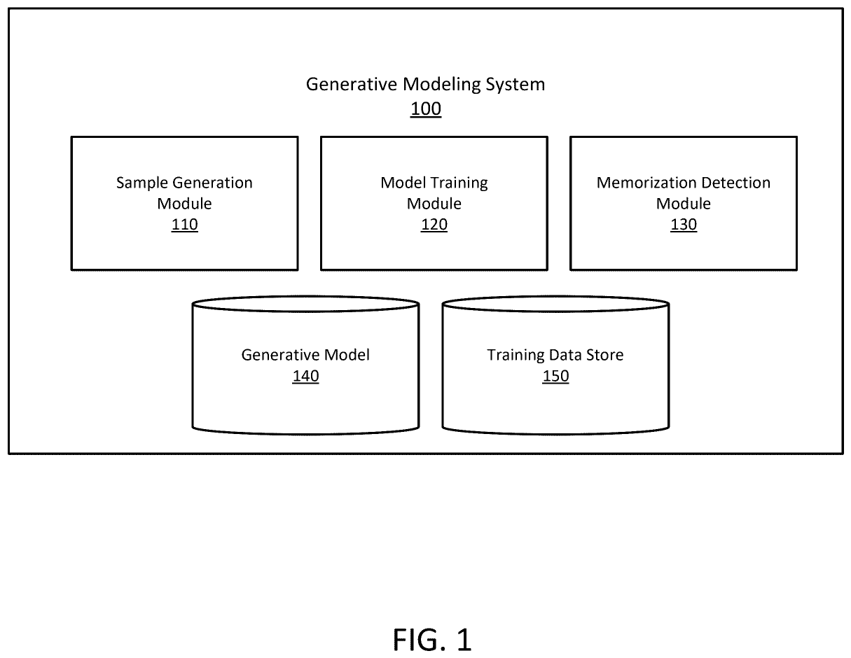

FIG. 1 illustrates an example generative modeling system 100, according to one embodiment. The generative modeling system 100 trains and applies a generative model 140 that may create new data samples based on learned parameters of the generative model 140. Although, for convenience, the model training and model application (i.e., new data sample generation) are discussed herein as performed by the generative modeling system 100; in practice, one system (or set of systems) may train the generative model 140 and another set of systems may apply the generative model 140 to generate new data samples. As discussed further below, the generative modeling system 100 may use a “geometric” understanding of the generative model 140 to detect model memorization based on a local intrinsic dimensionality (LID) of a data sample according to the model's parameters. The LID as evaluated for a data sample (x) according to the model parameters θ may be denoted LID_{θ}(x). Similarly, the “ground truth” LID for a data sample may be denoted as LID*(x). The detected memorization based on the model LID_{θ}(x) may then be used in conjunction with sample generation and model training to prevent memorized samples from use or to reduce the memorized data samples during training of the generative model 140.

In general, a set of training data samples, which may be stored in a training data store 150, may be used to train the generative model 140. The particular type of training data differs across different embodiments and may include images, video, text, tabular data, and other types of data. The training data generally may include hundreds, thousands, millions, or more of individual data samples for use by a computer model. Each data sample may include a number of features/values that vary across a number of dimensions and may be organized as an array, matrix, or other high-dimensional structure. For example, a multi-color image is generally composed of a matrix comprising dimensions corresponding to the height and width of the image and a number of color channels, such that an individual pixel (i.e., a position) in the image is described by a particular height, width, and color values for each color channel. Each data sample may also include a number of labels or other additional information used for training the generative model 140. Images are generally used in this disclosure as an example of a type of data sample that may be used; additional types of data samples with additional characteristics may be used in other embodiments.

This natural data is often observed, captured, or otherwise represented in a “high-dimensional” space of n dimensions ( [symbol] ⁿ). While the data may be represented in this high-dimensional space, data of interest typically exists on a manifold [symbol] having lower dimensionality [symbol] ^{m} than the high-dimensional space (n>m). The manifold dimensionality may also be referred to herein as a dimensionality of a latent space that may be mapped to the manifold or as the “intrinsic” dimensionality of the data set, which may differ in different regions of the data set. As such, the overall manifold learned by the model may be a “union of manifolds” representing the different manifolds in different regions of the data. In general, the data samples in the training data store 150 exist in such a “high-dimensional” space. As one example, for image data, the “high-dimensional” space in which images could exist includes all possible color values across all color channels at each pixel position across the height and width of an image. Meanwhile, the training data for particular applications typically occupies a small subset of those possible images.

During the training process, the generative model 140 attempts to learn the relevant regions of the high-dimensional space (together forming a manifold [symbol] ) and, typically, a probability distribution across it. The generative model 140 may be referred to as a “deep” generative model as it may include a large number of model parameters and multiple layers of model parameters that may be modified during the training process to learn the relevant regions and probability distribution. The particular number of tunable parameters for the generative model 140 varies in different embodiments and may include hundreds, thousands, tens of thousands, millions, or more tunable parameters. Generative models 140 may particularly include diffusion models (DMs) which are capable of learning low-dimensional structure and are prone to memorization. However, the approach discussed herein applies to any generative model with a continuous data space on which latent intrinsic dimensionality may be evaluated. Thus, various types of generative models 140 may be used in different embodiments, and may include variational autoencoders (VAEs), normalizing flows (NFs), and diffusion models (DMs). In general, these models attempt to learn the unknown probability distribution of the ground truth distribution by maximizing the likelihood of the training data. As such, the generative model 140 can include a probability distribution that can be sampled from and transformed to a point (i.e., a data sample) in the high-dimensional space. For example, in a normalizing flow, data may be sampled from a probability distribution (e.g., a Gaussian distribution) in a latent space (which may be of a lower dimensionality) and transformed from the latent space to the high-dimensional space of the output sample according to a learned transform.

In various embodiments, the generative model 140 may also be trained to generate data samples in conjunction with a query. The training data store 150 may include one or more queries associated with each training data sample, such that the generative model 140 learns to generate data samples based on an input query. The query may typically be a sequence of textual tokens, such as a sentence associated with and describing the data sample.

A model training module 120 trains the generative model 140 based on the set of training data samples from the training data store 150. The model training module 120 may use any suitable machine-learning techniques to train parameters of the generative model 140 based on the type and architecture of the generative model 140. Such techniques may include supervised or unsupervised training techniques, evaluation of error/loss functions, backpropagation, gradient descent, and so forth, which may vary in different embodiments and for different applications.

In general, the generative model 140 may aim to reproduce a ground truth probability distribution based on the training data samples drawn from the ground truth probability. However, the trained generative model 140 may overfit the data and “memorize” training data samples by reproducing (or near-reproducing) training data samples or fail to accurately capture the ground truth probability distribution by learning a manifold having a lower local intrinsic dimensionality than is actually present in the ground truth distribution. Both of these errors may be termed “memorization” as used herein. As discussed further below, a memorization detection module 130 may detect memorization based on the local intrinsic dimensionality of a data sample according to the generative model 140 parameters (i.e., LID_{θ}(x)).

### Low Model Local Intrinsic Dimensionality Signifies Memorization

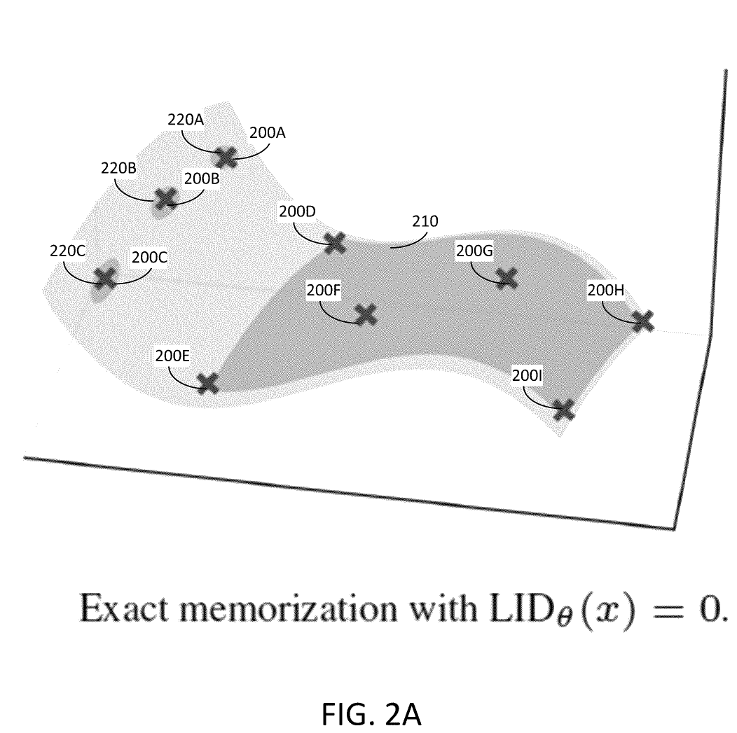

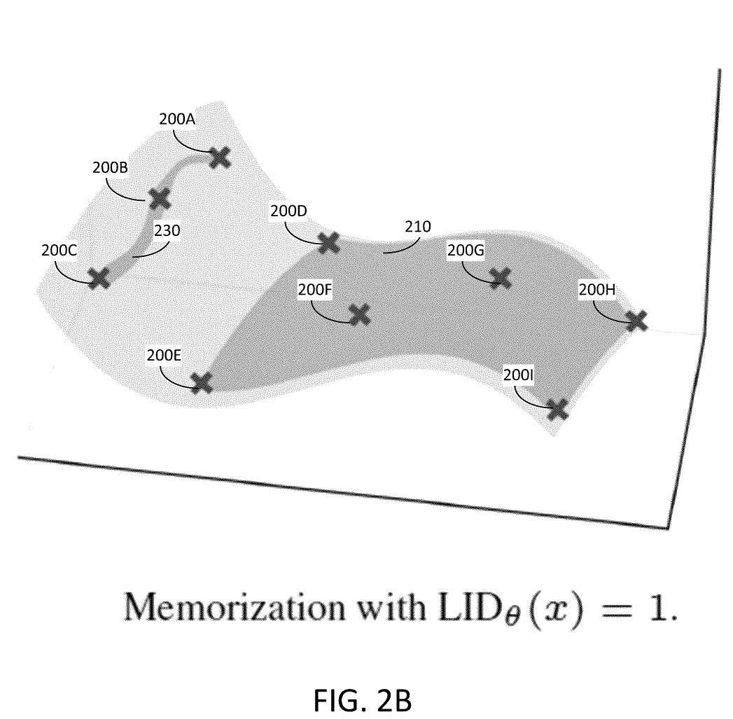

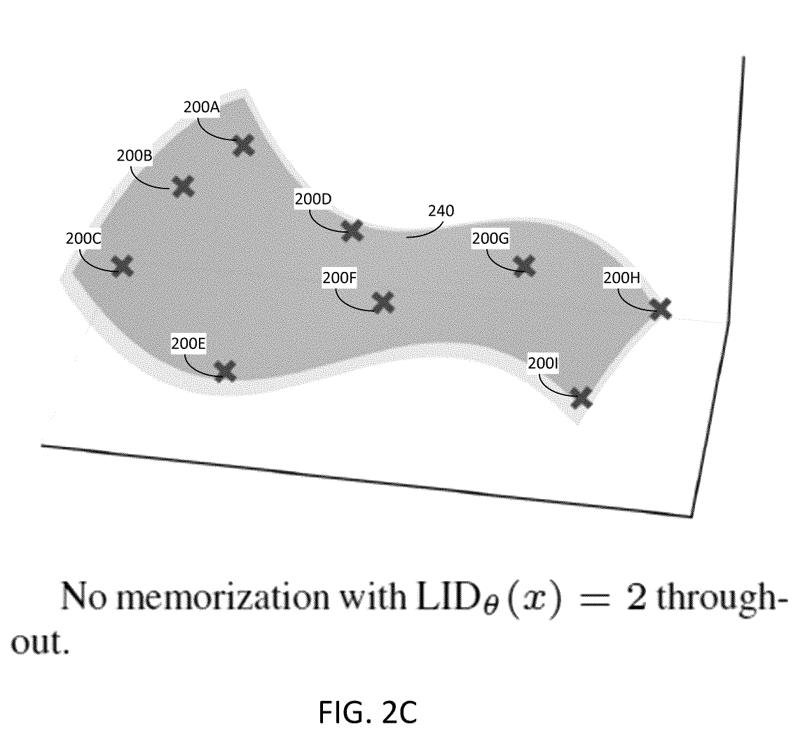

FIGS. 2A-C show example training samples with learned manifolds and memorization indicated by local intrinsic dimensionality. The examples of FIG. 2A-C show possible models trained on a data set of training data samples 200A-I. The training data samples 200A-I are drawn from a ground truth distribution with LID*(x)=2. However, it may be possible in various situations for the model to fail to learn the proper ground truth distribution across the data set. In the first example of FIG. 2A, the model has learned a region 210 that captures training data samples 200D-I, with a LID_{θ}(x) of 2. However, the model has also learned zero-dimensional manifolds 220A-C that memorize respective training data samples 200A-C with LID_{θ}(x)=0. The learned manifold for these zero-dimensional manifolds 220A-C (as indicated by the LID of zero) indicate that the model does not have any degrees of freedom around those points, such that these points are effectively “memorized” by the model and may be reproduced when samples are drawn from the generative model.

FIG. 2B shows an additional example in which the model has more-effectively learned the training data samples 200A-C by learning a 1-dimensional manifold 230 connecting training data samples 200A-C. As such, evaluating training data samples 200A-C may yield LID_{θ}(x)=1, indicating the one-dimensional manifold 230 between them. In this instance, although the model may generate data samples that differ from the individual training data samples 200A-C, these different data samples may only be generated in the limited region along the one-dimensional manifold 230. In this case, the model may be considered to “memorize” the training data samples because it may insufficiently generalize to the higher dimensionality of the training data set as a whole. Specifically, the learned local intrinsic dimensionality LID_{θ}(x) through the one-dimensional manifold 230 is smaller than the ground truth local intrinsic dimensionality LID*(x) and thus fails to successfully generalize from the training data samples.

This situation of FIG. 2B may characterize memorization more complex than simply reproducing a data sample. For example, there may be instances where layouts, styles, or foreground or background objects in training images are copied without copying the entire image. In the region of these data samples, the generative model is able to generate images with degrees of freedom in some attributes (e.g., color or texture), but is too constrained in other attributes (e.g., layout, style, or content). Geometrically, the learned model manifold is “too constrained” compared to the idealized ground truth manifold (LID*(x)<LID_{θ}(x)).

Finally, FIG. 2C shows an example in which the model successfully learns a manifold 240 having LID_{θ}(x)=2 for each training data sample 200A-I. As shown by these examples, evaluating the LID_{θ}(x) for training data samples can indicate when a model has memorized training data samples.

FIG. 3 shows an example of memorization detectable with latent intrinsic dimensionality for a von Mises distribution, according to one or more embodiments. A von Mises distribution is a 1-dimensional circle in a 2-dimensional plane and has a probability distribution 300 heavily weighted on the right and lightly weighted on the left, as shown in FIG. 3. Because its support is 1-dimensional, every point in the von Mises distribution has a known ground truth distribution of 1 (LID*(x)=1). FIG. 3 shows a result from a simple experiment in which 100 training data samples were sampled (indicted by each X) from the von Mises distribution. Consistent with the distribution 300, most training data samples are clustered in an arc 310 around the higher probability area of the distribution on the right side. By chance, the sampled points include two training data samples 320 more separated from the arc 310, and an isolated training data sample 330.

Next, a diffusion model was trained on the sampled training data samples and a set of data samples were sampled from the trained generative model. The generated samples are shown in display 340. In addition, the LID_{θ}(x) of each generated data sample was determined according to the parameters of the generative model. In this experiment, the LID_{θ}(x) was determined by the FLIPD estimator. As expected, the generated samples are consistent with the training data samples used to train the model, such that the generated data generally has the same distribution as the training data samples. Particularly notable is that the generated data samples 350 corresponding to the arc 310 have an evaluated LID_{θ}(x) close to or approximately 1, consistent with the ground truth distribution dimensionality LID*(x). However, the generated data samples 360 in the region corresponding to the separated training data samples 320 are evaluated to a lower LID_{θ}(x) below the known ground truth dimensionality LID*(x), and may indicate that this region has not correctly learned the ground truth distribution and may have some memorization in that region. In addition, while a generated data sample 370 is obtained from the model that corresponds to the isolated training data sample 330, this isolated data sample is reproduced nearly exactly and assigns it an LID_{θ}(x) of zero. As shown by this simple example, memorization by the generative model can be detected by evaluating LID_{θ}(x): local intrinsic dimensionality (LID) of a data sample (x) according to parameters θ of the generative model.

Returning to FIG. 1, a memorization detection module 130 may be used to evaluate memorization based on local intrinsic dimensionality of a data sample. The memorization detection module 130 may be used by a sample generation module 110 to evaluate samples generated by the generative model 140 to detect memorization of generated data samples. Similarly, the model training module 120 may use the memorization detection module 130 to detect memorization, particularly of training data samples during model training. When memorized data samples are identified, the sample generation module 110 and model training module 120 may take additional actions to reduce or prevent memorization or the use of memorized data samples.

Although these components are shown in FIG. 1 as part of a generative modeling system 100, in additional embodiments, these components may be located at various separate systems. For example, in one embodiment, the generative model 140 is trained by one computing system, while another computing system generates new data samples based on the trained generative model 140. Similarly, individual components of the generative modeling system 100 may also be distributed across multiple computing systems. For example, the model training module 120 may be distributed across multiple training systems, such that one set of systems is configured to jointly train the generative model 140, and another set of distributed systems is configured to apply the generative model 140 to create new data samples. Each of these systems may include a memorization detection module 130 to detect memorization for respective uses of the generative model 140.

### Memorization Detection with LID

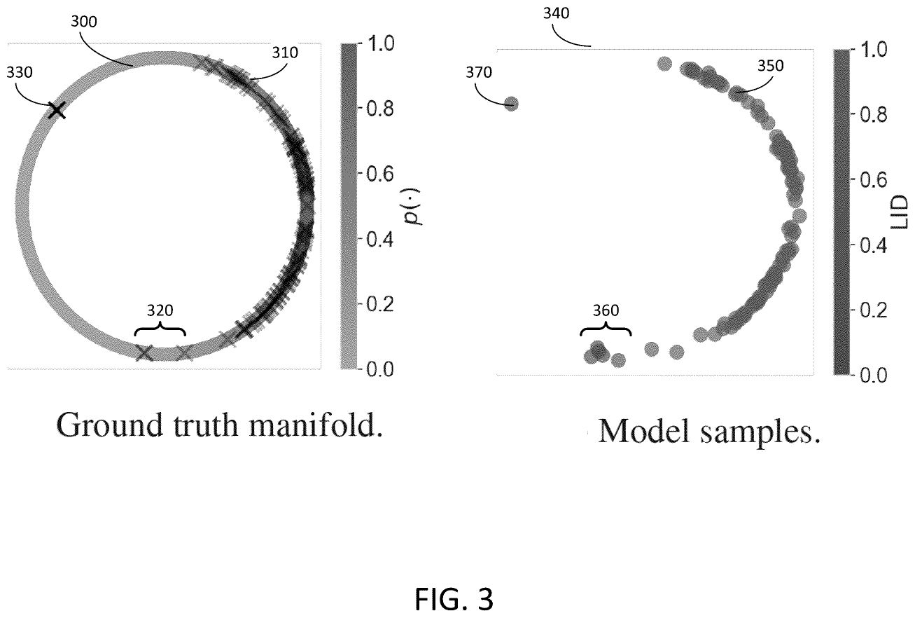

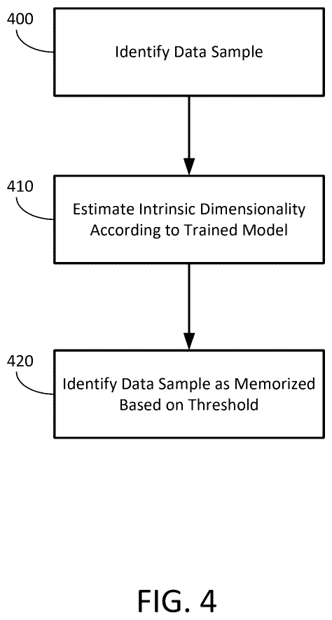

FIG. 4 is a flowchart of an example process for detecting memorization of a data sample by a generative model, according to one embodiment. Initially, a data sample to be evaluated is identified 400, which may be, for example, a training data sample, generated data sample, or a data sample from another source. That is, the local intrinsic dimensionality is measured with respect to a particular data sample based on the trained parameters of the generative model. For different data samples (in different portions of the data space), for different trained parameters and for different generative models, the local intrinsic dimensionality may vary.

Next, the local intrinsic dimensionality LID_{θ}(x) is determined for that data sample x according to parameters θ of the generative model. As such, in general, the evaluated LID represents a “geometric” understanding of the model's dimensionality at the evaluated data sample and may represent the degrees of freedom of the model to generate different data samples (e.g., according to an implicitly or explicitly learned manifold at the data sample). The specific method for determining the local intrinsic dimensionality may vary in different embodiments and may differ according to the type of generative model used. As one example, local intrinsic dimensionality for model parameters with respect to a data sample may be evaluated using the “FLIPD” estimator, which applies a Fokker-Planck equation to diffusion models. As additional examples, the local intrinsic dimensionality may be based on normal bundles (NB), local principle component analysis (PCA), or the rank of the Jacobian of the generative model at the data sample.

After determining the local intrinsic dimensionality LID_{θ}(x), the LID for that data sample may be compared to a threshold to identify 420 the data sample as memorized. The data sample may be identified when the model has insufficient degrees of freedom, such that the generative model reproduces the data sample (or minor variations thereof). To detect this type of memorization, the local intrinsic dimensionality LID_{θ}(x) is compared with a low value such as zero, one, two, five, or a similar range to detect reproduction of the data sample. This reproduction may be relevant even when the generative model correctly learns the ground truth LID. For example, generative models may include an associated query that affects the generated image; and, for highly-specific query terms (e.g., the specific name of a famous work of art such as “The Great Wave off Kanagawa by Katsushika Hokusai”), there may be little variation in the training data samples (or the underlying probability distribution) in data samples associated with that query, such that the generative model may be “correctly” learning to memorize a data sample when provided that query. By assessing the local intrinsic dimensionality LID_{θ}(x) of the data sample, this type of memorization can be identified with a low (i.e., absolute) threshold that may detect memorization (as reproduction) irrespective of the underlying ground truth distribution. This type of memorization may reflect, for example, the reproduction of the isolated data sample 370 as shown in FIG. 3

In additional examples, the threshold may be set to identify “memorized” data samples based on the local intrinsic dimensionality LID_{θ}(x) providing insufficient degrees of freedom relative to what may be expected or known for the ground truth local intrinsic dimensionality LID*(x). In this circumstance, a data sample may be identified as memorized when LID_{θ}(x) is less than (or substantially less than) LID*(x). This may detect, for example, the generated data samples 360 of FIG. 3. The threshold in this example may be set based on an estimated LID*(x) for a known or predicted dimensionality of the data distribution or a ground truth dimensionality of the data sample or data domain. For example, in some situations, the data space may model environments or systems having a known or predicted number of degrees of freedom characterizing the environment/system. In other examples, the threshold may be set based on a LID calculated for one or more training data samples, which may be calculated independent of the generative model parameters. Various LID estimation approaches may be used to generate LID estimates for data samples separate from the generative model. For example, LIDL is one approach that determines LID estimates for data samples by training normalizing flows on the data set with different levels of noise. In this example, the threshold for detecting memorization may be set to the ground truth local intrinsic dimensionality LID*(x) or a portion (0.5, 0.8, etc.) thereof. Then, memorization characterized by insufficient “flexibility” may be geometrically detected when the model's LID evaluated for a data sample LID_{θ}(x) is below the threshold based on the estimated 410 dimensionality based on the training data/ground truth LID*(x).

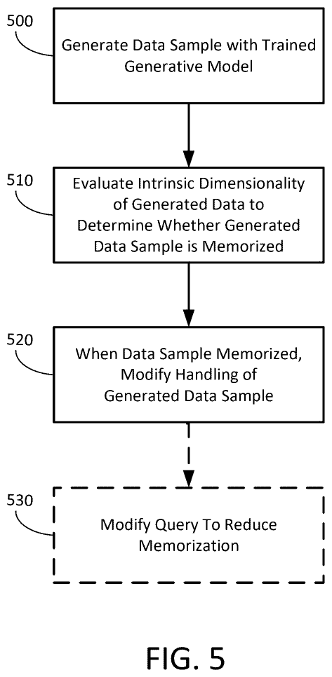

FIG. 5 shows an example method for detecting memorization for generated model samples, according to one embodiment. This method may be performed, for example, by a sample generation module 110. Initially, a request to generate a data sample may be received, which, in some configurations, may include a query describing the data sample to be generated. The query may include, for example, a sequence of tokens (e.g., text tokens) for application to the generative model for generating the data sample. A data sample is then generated 500 by the generative model and may be evaluated 510 to determine whether the generated data sample is memorized as discussed above. When evaluating generated data samples, in general, the threshold to detect memorization may determine whether the generated data sample may be set near zero (i.e., zero, one, two, etc.). Of particular interest, this approach for detecting memorization may identify memorized data samples with the local intrinsic dimensionality of the generated data sample according to the model's parameters, such that memorization may be detected without requiring comparison with training data samples (which may require analysis and identification of both a “close” training data sample and a measure of the difference with that training data sample).

When the generated data sample is determined to be memorized, the handling 520 of the generated data sample may be modified relative to a normal handling of generated data samples. For example, normal generated data samples may be returned to the requestor responsive to the request. When the data sample is determined to be memorized based on the local intrinsic dimensionality LID_{θ}(x), the data sample may be prevented from delivery as a response to the query. This may prevent reproduction and distribution of “generated” data samples that are actually the same or substantially similar to training data samples. In some embodiments, when the generated data sample may be a reproduction of a training data sample, the generated data sample may then be evaluated for additional permissions to determine whether the generated data sample may be provided to the requesting entity.

In one or more embodiments, to address the apparent memorization and address the potential memorization, the query may be modified 530 to generate an alternate data sample that may be returned as a response to the query. To effectively modify the query while maintaining the intent of the query, the query may be modified in various ways. As one example, one or more tokens of the query may be modified by differentiating the query with respect to the local intrinsic dimensionality, such that the tokens can be identified that most contribute to (and when modified, may increase) the LID. These tokens may then be modified with substitute or alternate tokens for generating an alternate data sample. In one embodiment, the query and the identified tokens may be provided to a large language model with a prompt requesting a modification of the query that replaces the identified tokens while maintaining the intent of the query. In this way, the large language model may be leveraged for its ability to flexibly interpret and reword queries while maintaining the query intent. The modified query may then be applied to the generative model to generate an alternate data sample expected to have a higher local intrinsic dimensionality and be less likely to be a data sample memorized by the model. The alternate data sample may then be evaluated for its LID_{θ}(x) and provided as a response to the request. In some embodiments, the modified query may also be provided to indicate the modified query used for generating the data sample.

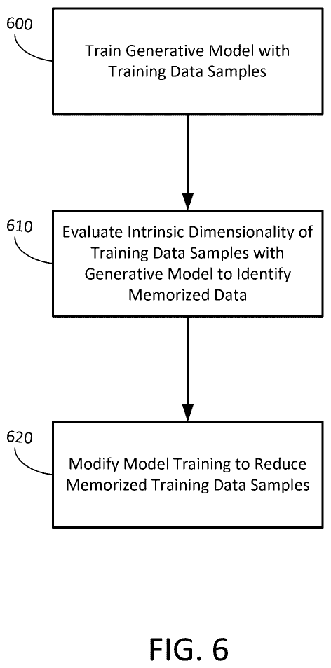

FIG. 6. is an example process for using data memorization during model training, according to one embodiment. This approach may be used, for example, by a model training module 120 discussed above. Initially, a generative model is trained 600 based on a set of training data samples. Alternatively, a pre-trained generative model may be identified and evaluated for data sample memorization. Rather than evaluating generated data samples, the LID_{θ}(x) of the trained generative model may be evaluated 610 for the data samples that trained the model to confirm that the model has sufficiently generalized from the training data. The threshold for detecting memorization may be set to identify reproduced data samples as well as insufficiently generalized data samples represented by the learned LID lower than the expected LID for the ground truth distribution (i.e., LID_{θ}(x)<LID*(x)).

When training data samples are identified as memorized from the evaluation 610, the model training may be modified 620 in various ways to reduce the memorized data samples. This may occur in various ways in various embodiments and may include modifying the model architecture, training, and training data samples to affect the number of memorized training data samples. The training data samples may be increased, removed, or otherwise modified based on the memorization.

As one example, when the training data sample is evaluated with a low LID_{θ}(x) close to zero, this may represent a portion of the data space with few to no nearby data samples as shown in FIG. 3. In this circumstance, the training data may be modified to remove these memorized training data samples and the model may be retrained such that the retrained model does not have access to data samples that the model tends to memorize.

As another example, when the training data sample is evaluated with a low LID_{θ}(x) relative to expected local dimensionality (LID_{θ}(x)<LID_{θ}(x)), this may indicate that the model has not effectively learned the region around the training data sample. In one or more embodiments, the training data in that region may be augmented to increase the training data samples and increase a likelihood that the generative model may correctly learn the dimensionality of that region. As one embodiment, additional data samples may be drawn from the distribution (i.e., for image data, additional training data may be captured and/or labeled). Additionally or alternatively, additional data samples may be generated synthetically around the area of the memorized training data sample. By adding additional training data samples and further training the model in the area in which the generative model was detected to memorize training data samples, the generative model may better learn parameters for generalizing towards the expected ground truth dimensionality LID*(x).

By detecting the local intrinsic dimensionality of data samples (generated by the model or as training data samples), areas in which the parameters of the model have memorized training data or have under-generalized the data space can be identified and addressed. This enables detection of generated data samples that are too similar to training data samples as well as improved training of generative models to detect and address memorization.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system, comprising:
one or more processors that execute instructions; and
one or more computer-readable media having instructions executable by the one or more processors for:
identifying a data sample generated responsive to a query by a trained generative model having a set of trained parameters;
estimating a local intrinsic dimensionality of the data sample according to the set of trained parameters of the trained generative model;
determining that the data sample is memorized by the trained generative model when the local intrinsic dimensionality of the data sample is below a threshold; and
responsive to determining that the data sample is memorized, preventing delivery of the data sample as a response to the query.

2. The system of claim 1, wherein the threshold is in a range from zero to five.

3. The system of claim 1, wherein the threshold is determined based on an estimated dimensionality of a training data set of the trained generative model.

4. The system of claim 1, wherein the instructions executable by the one or more processors are further for:
modifying the query to a modified query;
determining a modified data sample by applying the generative model to the modified query; and
providing the modified data sample as the response to the query.

5. The system of claim 4, wherein modifying the query to the modified query comprises:
determining a contribution of one or more tokens in the query to the local intrinsic dimensionality; and
modifying the query based on the contribution of the one or more tokens.

6. The system of claim 5, wherein determining the contribution of one or more tokens in the query to the local intrinsic dimensionality comprises differentiating the local intrinsic dimensionality with respect to the one or more tokens.

7. The system of claim 5, wherein modifying the query comprises providing the query to a large language model.

8. A method, comprising:
identifying a data sample generated responsive to a query by a trained generative model having a set of trained parameters;
estimating a local intrinsic dimensionality of the data sample according to the set of trained parameters of the trained generative model;
determining that the data sample is memorized by the trained generative model when the local intrinsic dimensionality of the data sample is below a threshold; and
responsive to determining that the data sample is memorized, preventing delivery of the data sample as a response to the query.

9. The method of claim 8, wherein the threshold is in a range from zero to five.

10. The method of claim 8, wherein the threshold is determined based on an estimated dimensionality of a training data set of the trained generative model.

11. The method of claim 8, the method further comprising:
modifying the query to a modified query;
determining a modified data sample by applying the generative model to the modified query; and
providing the modified data sample as the response to the query.

12. The method of claim 11, wherein modifying the query to the modified query comprises:
determining a contribution of one or more tokens in the query to the local intrinsic dimensionality; and
modifying the query based on the contribution of the one or more tokens.

13. The method of claim 12, wherein determining the contribution of one or more tokens in the query to the local intrinsic dimensionality comprises differentiating the local intrinsic dimensionality with respect to the one or more tokens.

14. The method of claim 12, wherein modifying the query comprises providing the query to a large language model.

15. A non-transitory computer-readable medium, the non-transitory computer-readable medium, comprising instructions executable by a processor for:
identifying a data sample generated responsive to a query by a trained generative model having a set of trained parameters;
estimating a local intrinsic dimensionality of the data sample according to the set of trained parameters of the trained generative model;
determining that the data sample is memorized by the trained generative model when the local intrinsic dimensionality of the data sample is below a threshold; and
responsive to determining that the data sample is memorized, preventing delivery of the data sample as a response to the query.

16. The non-transitory computer-readable medium of claim 15, wherein the threshold is in a range from zero to five.

17. The non-transitory computer-readable medium of claim 15, wherein the threshold is determined based on an estimated dimensionality of a training data set of the trained generative model.

18. The non-transitory computer-readable medium of claim 15, the instructions being further executable for:
modifying the query to a modified query;
determining a modified data sample by applying the generative model to the modified query; and
providing the modified data sample as the response to the query.

19. The non-transitory computer-readable medium of claim 18, wherein modifying the query to the modified query comprises:
determining a contribution of one or more tokens in the query to the local intrinsic dimensionality; and
modifying the query based on the contribution of the one or more tokens.

20. The non-transitory computer-readable medium of claim 19, wherein determining the contribution of one or more tokens in the query to the local intrinsic dimensionality comprises differentiating the local intrinsic dimensionality with respect to the one or more tokens.
